(19) United States
(12) Patent Application Publication
(10) Pub. No.: US 2023/0022656 A1
(43) Pub. Date: Jan. 26, 2023

(54) DEVICE FOR MOBILIZING THE HUMAN OSTEO-MUSCULOTENDINOUS SYSTEM

(71) Applicants: CAPITAL INNOVATION, Cairon (FR); SERAF PHYSIO PRO, Le Castelet (FR)

(72) Inventors: Thomas SERAFIN, Le Castelet (FR); Mathias TENAILLE D'ESTAIS, Caen (FR); Jean-Yves CORBIN, Le Fresne Camilly (FR); Maxime VAUPRES, Grentheville (FR)

(21) Appl. No.: 17/757,193

(22) PCT Filed: Dec. 18, 2020
(86) PCT No.: PCT/EP2020/086974

§ 371 Date: Jun. 10, 2022

(30) Foreign Application Priority Data
Dec. 23, 2019 (FR) FR1915465

(51) Int. Cl. A61H 1/02; A61H 1/00

(52) U.S. Cl. CPC A61H 1/0259; A61H 1/006; A61H 2201/1642; A61H 2201/1645; A61H 2201/1654; A61H 2201/1676; A61H 2201/0149; A61H 2201/0142; A61H 2201/1628; A61H 2201/1253

(57) ABSTRACT

A device for mobilizing the human osteo-musculotendinous system, including a kneepad arranged to cover a knee of a human user so as to keep the knee in the kneepad, and arranged to exert, on the knee covered by the kneepad, a mobilizing force, the mobilizing force applying pressure to the knee and being directed towards a bearing surface arranged so that the user's pelvis can bear against said surface and a means for increasing the mobilizing force.

### TECHNICAL FIELD

The present invention relates to a device for mobilizing the human osteo-musculotendinous system.

The field of the invention is more particularly, but non-limitatively, that of devices for treating or diagnosing piriformis syndrome.

### STATE OF THE PRIOR ART

Piriformis syndrome is generally the result of a compression of the sciatic nerve or an irritation of the sciatic nerve by the piriformis muscle, and leads to pain felt in the buttock and sometimes to sciatica.

Piriformis syndrome is common and affects several populations: sportspeople, in particular high-level sportspeople, pregnant women or overweight people and lastly a final category of people of varied profiles and having various levels of activity, in particular certain professional categories at risk because of their work postures.

In order to ease or treat it, the following can currently be considered:
specific exercises for stretching the hip, and/or
surgery, and/or
corticosteroid injections.

Different manipulations of the osteo-musculotendinous system are known which make it possible to diagnose piriformis syndrome and/or to stretch the piriformis and/or to ease piriformis syndrome, such as the “FAIR” method. This consists of bringing the leg into hip flexion, then adduction, concluding with an internal rotation. The aim of this sequence of actions is to stretch the piriformis in a certain way, thus generally leading to a sensory feedback of pain in the patient having piriformis syndrome.

Solutions that can make it easier to carry out the procedures described above are known, such as the Piri-Stretcher®, a solution that makes it possible to mobilize the knee (and the leg) with a handle that is attached to it.

The purpose of the present invention is to propose a device making it possible to mobilize the human osteo-musculotendinous system, preferably in a way that is suitable for piriformis syndrome, and:
significantly improving symptoms and in particular the pain, and/or
improving the control and/or repeatability of the value of the force exerted on the osteo-musculotendinous system, and/or
improving the control and/or repeatability of the movement undergone by the osteo-musculotendinous system, and/or
making the practitioner's activity easier by limiting the effort to be applied, and/or
making a direct personal use possible without the intervention of a practitioner.

### DISCLOSURE OF THE INVENTION

This objective is achieved with a device for mobilizing the human osteo-musculotendinous system comprising:
a kneepad (i.e. at least one kneepad, but preferably a single kneepad), arranged to cover a knee of a human user so as to hold the knee in the kneepad, and arranged to exert a mobilizing force on the knee covered by the kneepad,
   this mobilizing force putting pressure on the knee and being directed towards a bearing surface arranged to support the user's pelvis and
   this mobilizing force having a direction that can lead from the kneepad to the bearing surface,
means for increasing the mobilizing force.

The direction of the mobilizing force is preferably contained in a mobilizing force exertion plane.

The device according to the invention preferably moreover comprises means arranged to constrain, during the increase in the mobilizing force by the force-increasing means, the relative movement of the kneepad with respect to the bearing surface according to a constrained course.

The means arranged to constrain the relative movement of the knee with respect to the bearing surface are preferably arranged to keep the position of the mobilizing force exertion plane fixed during the increase in the mobilizing force.

The means arranged to constrain the relative movement of the knee with respect to the bearing surface can be arranged to keep the direction of the mobilizing force fixed during the increase in the mobilizing force.

The means for increasing the mobilizing force can comprise:
a grip element which is attached to the kneepad and on which the user can pull manually when their pelvis is on the bearing surface, and/or
a restoring means, such as a spring, exerting a restoring force on the kneepad towards the bearing surface, and means for compensating for this restoring force, and/or
a step attached to the kneepad and arranged to receive a foot of a practitioner separate from the user so as to increase the mobilizing force by increasing a force exerted by the practitioner on the step, and/or
a bearing platform (forming for example a lever arm activated by the hand or foot or knee or a buttock of a practitioner or by a motor or by the user by mobilizing their hand or their foot belonging to the knee not attached to the kneepad) arranged to apply the mobilizing force to the knee that is attached to the kneepad by a traction of the kneepad or to the bearing surface, and/or
a weight attached to the kneepad and preferably a sliding surface arranged to guide, by the gravitational effect, a fall of the weight and the kneepad along the sliding surface against the user's knee, and/or
a receiving surface which is attached to the kneepad and forms a corner with the bearing surface, and means for adjusting the distance between the kneepad and the corner, and/or
means for increasing a volume of an interface arranged inside the kneepad and provided to be arranged between the kneepad and the knee, and/or
means for increasing a volume of an interface arranged on the bearing surface and provided to be arranged between the bearing surface and the pelvis.

The means for increasing the mobilizing force can be arranged to increase this mobilizing force while decreasing a distance between the kneepad and the bearing surface.

The means for increasing the mobilizing force can be arranged to increase this mobilizing force while increasing a distance between the kneepad and a plane tangential to the bearing surface.

The device according to the invention can comprise at least one linking element connecting:
the kneepad or an element attached to the kneepad
to the bearing surface or to an element attached to the bearing surface.

The at least one linking element can comprise at least one strap or a rod.

The device according to the invention can comprise at least one restoring means that is elastic (in extension and/or in compression) along the at least one linking element, said restoring means having a given rigidity along the mechanical link connecting the kneepad to the bearing surface.

The device according to the invention can comprise means for replacing the at least one restoring means from different restoring means with different rigidity and/or means for varying the rigidity of the at least one restoring means.

The device according to the invention can comprise, on the bearing surface or on an element attached to the bearing surface, a pivot pin of the kneepad, the at least one linking element connecting the pivot pin of the kneepad to the kneepad and being arranged to pivot about the pivot pin, causing the kneepad to pivot about the pivot pin.

The device according to the invention can comprise a mark or a stop arranged to make it possible to position the user's pelvis offset with respect to the pivot pin.

The means for increasing the mobilizing force can be arranged to increase this mobilizing force by pivoting the kneepad about the pivot pin such that the pivot pin of the kneepad is offset with respect to the pivot point of the knee with respect to the pelvis.

The at least one linking element can comprise an inextensible and/or incompressible rod attached to the kneepad, the means for increasing the mobilizing force being arranged to increase this mobilizing force by pivoting the inextensible and/or incompressible rod about the pivot pin.

The at least one linking element can comprise two straps connecting two sides of the kneepad to two anchoring points arranged along the pivot pin, the means for increasing the mobilizing force being arranged to increase this mobilizing force by pivoting the straps about the pivot pin.

The device according to the invention can comprise means arranged to modify a lever arm applied to the kneepad during its rotation about the pivot pin.

The means for increasing the mobilizing force can comprise means for shortening the at least one linking element.

The bearing surface preferably forms part of the device according to the invention and comprises:
a seat (for the user's pelvis), and/or a backrest (for the user's back), and/or
a backrest of a chair or an armchair, and/or
a treatment or massage table, and/or
a bed and/or an overall resting surface for the body.

The kneepad can comprise:
a central area intended to be in contact with the patella of the knee and a peripheral area intended to surround the patella of the knee, the peripheral area having a greater rigidity than the central area, or
an empty central area intended to be located at the patella of the knee and a peripheral area intended to surround the patella of the knee.

The kneepad can form part of a set of two attached kneepads.

The device according to the invention can comprise a system for measuring the value of the mobilizing force.

The device according to the invention can comprise an information means (by display, or sound, etc.) that informs the user of the value of the mobilizing force achieved.

The device according to the invention can comprise a means of capping the mobilizing force applied, in particular for the purposes of making it safe to use.

The kneepad and/or the bearing surface can comprise at least one restoring means that is elastic (in extension and/or in compression), said restoring means having a given rigidity arranged to have an influence on the mobilizing force exerted from the kneepad towards the bearing surface.

### DESCRIPTION OF THE FIGURES AND EMBODIMENTS

Other advantages and features of the invention will become apparent on reading the detailed description of embodiments and implementations which are in no way limitative, and from the following attached drawings:

FIG. 1 is a diagrammatic profile view of a first embodiment of the device according to the invention,

FIG. 2 is a diagrammatic profile view of a second embodiment of the device according to the invention,

FIG. 3 is a diagrammatic profile view of a third embodiment of the device according to the invention,

FIG. 4 comprises different diagrammatic views a) (front view) b) (profile view) of a fourth embodiment of the device according to the invention,

FIG. 5 is a diagrammatic profile view of a fifth embodiment of the device according to the invention,

FIG. 6 is a diagrammatic profile view of a sixth embodiment of the device according to the invention,

FIG. 7 is a diagrammatic profile view of a seventh embodiment of the device according to the invention,

FIG. 8 is a diagrammatic view of an eighth embodiment of the device according to the invention,

FIG. 9 is a diagrammatic profile view of a ninth embodiment of the device according to the invention,

FIG. 10 comprises different diagrammatic views a) b) of a tenth embodiment of the device according to the invention,

FIG. 11 comprises different diagrammatic views a) b) of an eleventh embodiment of the device according to the invention,

FIG. 12 comprises different diagrammatic views a) b) of a twelfth embodiment of the device according to the invention,

FIG. 13 comprises different diagrammatic profile views a) b) of a thirteenth embodiment of the device according to the invention, which is the preferred embodiment of the invention,

FIG. 14 is a perspective view of the thirteenth embodiment of the device according to the invention,

FIG. 15 is a diagrammatic profile view of a variant of the thirteenth embodiment of the device according to the invention,

FIG. 16 is a perspective view of a variant of the thirteenth embodiment of the device according to the invention,

FIG. 17 comprises different diagrammatic profile views a) b) c) d) of variants of the thirteenth embodiment of the device according to the invention,

FIG. 18 comprises different diagrammatic profile views a) b) c) of variants of the thirteenth embodiment of the device according to the invention,

FIG. 19 is a perspective view of a fourteenth embodiment of the device according to the invention,

FIG. 20 comprises different diagrammatic front views a) b) c) of the fourteenth embodiment of the device according to the invention,

FIG. 21 is a perspective view of a fifteenth embodiment of the device according to the invention,

FIG. 22 comprises different diagrammatic front views a) b) c) of the fifteenth embodiment of the device according to the invention,

FIG. 23 is a diagrammatic front view of a sixteenth embodiment of the device according to the invention,

FIG. 24 is a diagrammatic profile view of a kneepad that can be present in any of the embodiments of the device according to the invention described in the present description,

FIG. 25 is a perspective view of a seventeenth embodiment of the device according to the invention,

FIG. 26 is a diagrammatic profile view of the seventeenth embodiment of the device according to the invention,

FIG. 27 is a diagrammatic profile view of the seventeenth embodiment of the device according to the invention,

FIG. 28 is a diagrammatic profile view of the seventeenth embodiment of the device according to the invention.

As these embodiments are in no way limitative, variants of the invention can be considered in particular comprising only a selection of the characteristics described or illustrated hereinafter, in isolation from the other characteristics described or illustrated (even if this selection is isolated within a phrase containing these other characteristics), if this selection of characteristics is sufficient to confer a technical advantage or to differentiate the invention with respect to the state of the prior art. This selection comprises at least one, preferably functional, characteristic without structural details, and/or with only a part of the structural details if this part alone is sufficient to confer a technical advantage or to differentiate the invention with respect to the state of the prior art.

In all of the following embodiments of the device 100, the device 100 for mobilizing (by compressing the knee) the osteo-musculotendinous system of a human user comprises:
a kneepad 2, arranged to cover a knee 3 of a human user so as to hold said kneepad 2 supported on the knee 3 (at least on the periphery of the knee 3) and/or so as to hold the knee 3 in the kneepad 2, and arranged to exert a mobilizing force (typically greater than 30 kg and/or smaller than 120 kg) on the knee 3 covered by the kneepad 2:
   this mobilizing force putting pressure on the knee 3 and being directed towards a bearing surface 5 arranged to support the user's pelvis and
   this mobilizing force having a direction that leads from the kneepad 2 to the bearing surface 5 and being contained in a mobilizing force exertion plane 4.

The mobilizing force is therefore a force compressing the knee, preferably so as to generate a compression of the pelvis.

The force exertion plane 4 is preferably perpendicular to the bearing surface 5 as illustrated for the embodiments of all of the following figures.

The surface 5 is preferably flat.

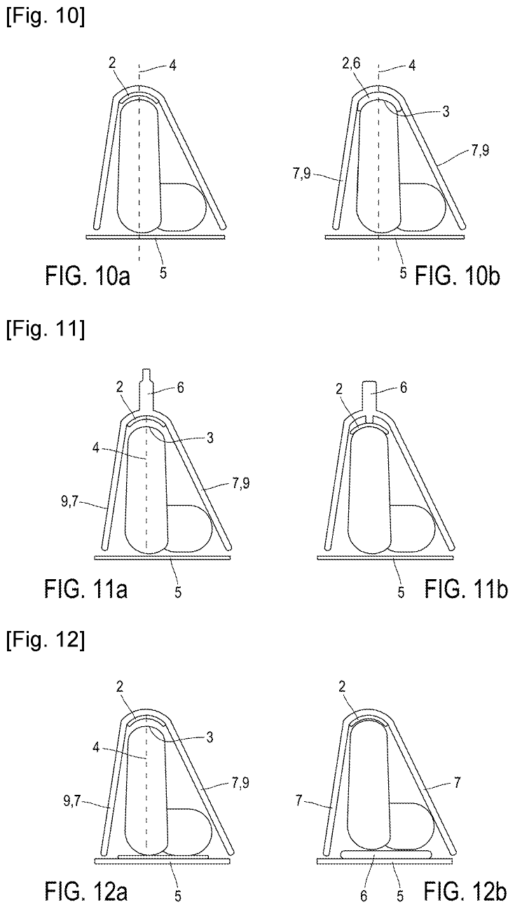

The device 100 moreover comprises means 6 for increasing (preferably gradually or continuously) the mobilizing force, preferably from a zero or low initial value (typically the weight of the kneepad 2, the presence of other elements the weight of which rests on the user's knee 3, or a certain preliminary tension due in particular to the initial placement of the device). This preliminary tension can, for certain designs, include a specific pre-tension action of the device of the order of from 10 to 300 N in order that the kneepad is best positioned and in order that the placement of the mobilizing force is more effective. This pre-tension is produced for example manually by activating the pawl of each regulating rack of the best mode or placing a component for generally adjusting the length of the straps in the designs in FIGS. 10 to 13.

The device 100 moreover comprises means 7 arranged to constrain, during the increase in the mobilizing force by the force-increasing means 6, the relative movement of the kneepad 2 with respect to the bearing surface according to a course constrained by the means 7.

The position of the mobilizing force exertion plane 4 can vary during the constrained course.

The surface 5 is a limited area intended to receive the user's pelvis.

In all of the following embodiments, the relative movement of the kneepad 2 with respect to the bearing surface 5 will be illustrated by a movement of the kneepad 2. Each of these embodiments can be modified by reversing or varying the mobility of the kneepad 2 and the surface 5 such that the kneepad 2 and/or the surface 5 is mobile.

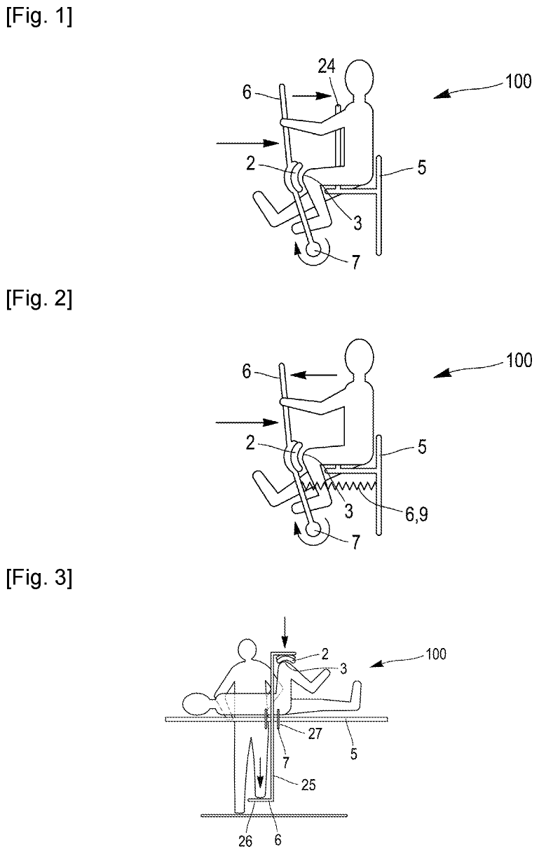

The surface 5 forms part of the device 100, for example in the form:
of a seat (for the user's pelvis), and/or of a backrest (for the user's back), and/or
of a backrest of a chair or an armchair (FIGS. 1, 2, 5, 6, and 7) or
of a mattress or of a table or of a bed (FIGS. 3, 4, and 8 to 23 and to 28).

In a variant, the surface 5 does not form part of the device 100, and the device 100 comprises fastening means (for example a system of jaws) arranged to fasten the device 100 to the surface 5.

By “cover” is meant that the kneepad 2 is arranged (at least during the exertion of a mobilizing force beyond a certain threshold, typically of kg) to mould (by deformation of the kneepad or not) to the shape of a knee 3 (typically according to a radius of curvature of at least 3 cm), so as to prevent the knee from slipping laterally (i.e. perpendicularly to the direction of the mobilizing force) out of the kneepad 2 when the kneepad 2 is in contact with and covers the knee 3.

Even if this is not necessarily illustrated for each of the embodiments illustrated in all of the figures, the kneepad 2 and/or the bearing surface 5 can comprise at least one restoring means 111 that is elastic (in extension and/or in compression).

Each restoring means 111 has a given rigidity arranged to have an influence on the mobilizing force exerted from the kneepad 2 towards the bearing surface 5. For example, the surface 5 can be a mattress filled with springs, and/or the kneepad 2 can be made of elastic material and/or equipped with springs.

For this design, a design with a single restoring means 111 will be described here, more particularly for a design of the type in FIGS. 1, 2, 3, 5, 6, 7 and 8, as well as 19 to 22, trials have been performed with the following restoring means:
Very elastic assembly, therefore suitable for frail and/or sensitive and/or small patients:
   F°, initial force, in other words minimum force to be applied in order to obtain a first deformation of the spring, equal to 254 N
   R, coefficient of rigidity of the spring equal to 1.84 N/mm With this equipment, a usage with quite a large elongation of the extensible linking element is frequently noted. The patients stop their muscle stretches when the elongation has reached a value of between 20 mm and 50 mm.

Here, the elongation of 20 mm corresponds to an applied force of: (F°+(R*20))=290 N

The elongation of 50 mm corresponds to an applied force of: (F°+(R*50))=346 N, which is greater but remains a very reasonable force in the sense that it presents little risk to the patient.
Very rigid assembly, therefore suitable for patients in good physical shape:
   F°, initial force, in other words minimum force to be applied in order to obtain a first deformation of the spring, equal to 800 N
   R, coefficient of rigidity of the spring equal to 55.8 N/mm

With this equipment, a usage with quite a small elongation of the extensible linking element is frequently noted. The patients stop their muscle stretches when the elongation has reached a value of between 10 mm and 15 mm.

The elongation of 10 mm corresponds to a force applied for the spring of: (F°+(R*10))=1358 N, which already corresponds to a pressure assessed to be high.

The elongation of 15 mm corresponds to a force applied for the spring of: F°+(R*15))=1637 N.

The first assembly can be considered as being well suited to the frailest patients and the second can be considered as being well suited to patients in very good physical shape, but it should be understood that the most important thing is the range of pressure applied to the knee, which is typically from 300 N to 1600 N.

The restoring means 111 therefore typically has a rigidity greater than 0.5 N/mm and/or smaller than 70 N/mm.

By an element that is “elastic in extension” is preferably meant in the present description an element which lengthens by more than 1% (preferably by more than 10%) of its initial length when it is subjected to a traction of 100 kg parallel to its length (which is preferably parallel to the mobilizing force).

By an element that is “elastic in compression” or “compressible” element is preferably meant in the present description an element which shortens by more than 1% (preferably by more than 10%) of its initial length when it is subjected to a compression of 100 kg parallel to its length (which is preferably parallel to the mobilizing force).

By an “inextensible” element is preferably meant in the present description an element which does not lengthen by more than 1% of its initial length when it is subjected to a traction of 100 kg parallel to its length (which is preferably parallel to the mobilizing force).

By an “incompressible” element is preferably meant in the present description an element which does not shorten by more than 1% of its initial length when it is subjected to a compression of 100 kg parallel to its length (which is preferably parallel to the mobilizing force).

In the particular case in FIGS. 2, 4, 6, and 8 to 23 and 25 to 28, the device 100 comprises at least one linking element 9 connecting:
the kneepad 2 or an element attached to the kneepad 2
to the bearing surface 5 or to an element attached to the bearing surface 5.

This at least one linking element 9 typically comprises at least one strap or a rod. Even if this is not necessarily illustrated, in the majority of the designs and in particular in each of the embodiments in FIGS. 3, 4, 6, and 8 to 23 and 25 to 28, at least one restoring means 11 that is elastic in extension and/or in compression can be placed along the at least one linking element 9, said restoring means 11 having a given rigidity or elasticity along the mechanical link connecting the kneepad 2 or an element attached to the kneepad 2 to the bearing surface 5 or to an element attached to the bearing surface 5.

As described for the means 111, each restoring means 11 therefore typically has a rigidity greater than 0.5 N/mm and/or smaller than 70 N/mm.

These means 11 have the effect of creating progressiveness, which provides ease of use and safety while in particular avoiding increases that are too abrupt and/or increases with excessively high values of the mobilizing force exerted by the kneepad 2 on the knee 3.

These means 11 can act as a means of capping the mobilizing force applied, in particular for the purposes of making the use of the device 100 safe during self-use. For example, with the previously described assembly with the coefficient of rigidity of the single spring equal to 1.84 N/mm, it is difficult to achieve forces of more than 50 Kg because this would require an extension of the spring no longer of 50 mm but of 130 mm, which is not very likely or can easily be avoided by the user and the practitioner.

The device 100 then preferably comprises means for replacing 13 the at least one restoring means 11 from different restoring means 11 with different rigidity and/or elasticity (for adapting this safety to different profiles or different morphologies of user); and/or means 14 for varying the rigidity of the at least one restoring means 11.

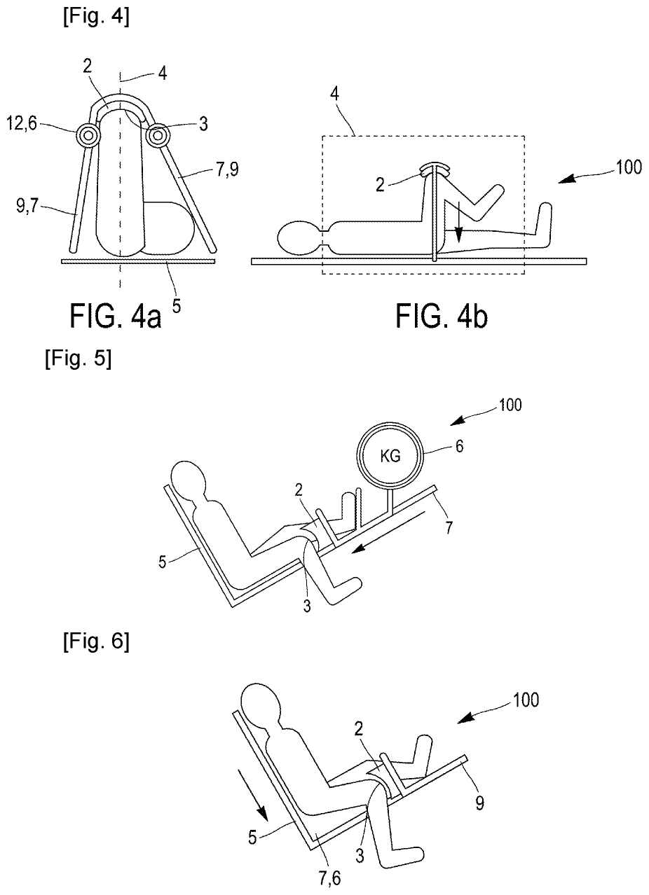

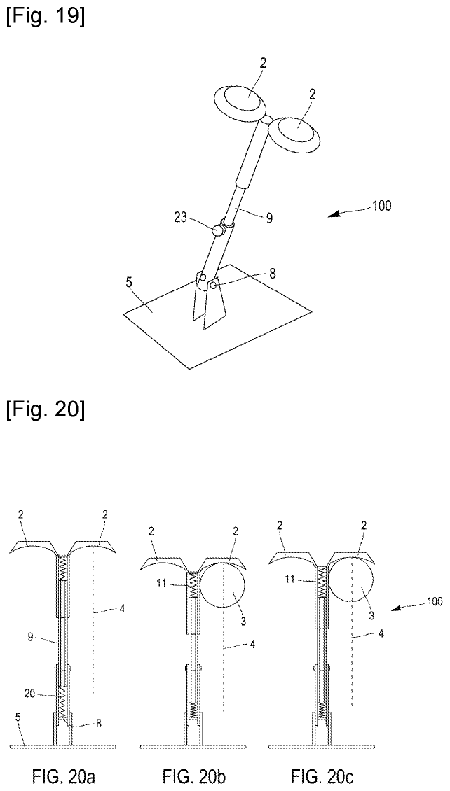

Each linking element 9 is:
in the case of FIG. 2: (a spring) that is elastic in extension and elastic in compression,
in the case of FIG. 6: (a panel) that is inextensible and incompressible (possibly provided with a compressible area 2 such as a shock-absorbing cushion)
in the case of FIGS. 4, 8, 9, 10, 11, 12, 13 to 18 and 23 and 25 to 28: (a strap) that is inextensible and compressible in a case without restoring means 11; and that is elastic in extension and compressible in the case of the presence of restoring means 11,
in the case of FIGS. 19 to 22: (a rod) that is inextensible and incompressible without restoring means 11; and that is elastic in extension and elastic in compression in the case of the presence of restoring means 11.

With reference to FIGS. 1 to 5 and 8 to 12, a first family of embodiments of devices 100 will be described first of all.

In the embodiments in FIGS. 1 to 5 and 8 to 12 the means 7 arranged to constrain the relative movement of the knee 3 with respect to the bearing surface 5 are arranged to keep the position of the mobilizing force exertion plane 4 parallel to the median plane of the user (i.e. in a sagittal plane of the user) fixed during the increase in the mobilizing force, more precisely to keep the direction of the mobilizing force fixed during the increase in the mobilizing force. This fixed direction of the mobilizing force is preferably perpendicular to the surface 5 and in the axis of the femur.

If the mobilizing force is not perpendicular to the surface 5, the user will feel a component of the force applied, parallel to the surface 5. This can create bodily discomfort through the tension that it causes and, if the component parallel to the surface 5 is large, this can result in a displacement of the patient's body by sliding on the surface 5, unless a wedging system is provided in order to prevent this phenomenon. The device according to the invention therefore preferably comprises such a wedging means arranged to block a sliding of the pelvis on the surface 5. This point is true if the mobilizing force is in the sagittal plane and this remains true if the mobilizing force is not in the sagittal plane.

If the mobilizing force does not have the axis of the femur as its direction, the user will feel a component of the force applied which induces a movement of the femur lifting or lowering the knee. The patient may possibly resist this force by activating the muscles of their leg, but this is unfavourable for the stretching sought, which requires the patient to relax the muscles. This point is true if the mobilizing force is in the sagittal plane and this remains true if the mobilizing force is not in the sagittal plane.

The “median plane” of the user is the plane that separates the left half of the user's body from the right half, and is preferably substantially a plane of symmetry of this body (when the latter is stretched out with the arms along the body). It is one of the innumerable “sagittal planes”, which are all parallel to the median plane.

The means 6 for increasing the mobilizing force are arranged to increase this mobilizing force while reducing a distance between the kneepad 2 and the bearing surface 5.

The means 7 arranged to constrain the relative movement of the kneepad 2 with respect to the bearing surface 5 according to a constrained course are arranged to constrain the relative movement of the kneepad 2 with respect to the bearing surface 5 according to a translational movement of the kneepad 2 in the direction of the surface 5.

The plane 4 is parallel to the plane of FIGS. 1, 2, 3, and 5.

With reference to FIG. 1, in the first embodiment of the device 100, the means 6 for increasing the mobilizing force comprise a grip element (such as a lever or a handle) which is attached to the kneepad 2 and on which the user can pull manually when their pelvis is on the bearing surface 5, so as to pull the kneepad 2 towards the bearing surface.

A reinforcement 24 is arranged to immobilize their pelvis against the surface 5.

The bearing surface 5 forms part of the device 100 and comprises a backrest of a chair or an armchair.

The means 7 comprise a pivot joint that allows only one rotation of the kneepad 2 parallel to the plane 4, which remains fixed.

A mechanism (not illustrated), for example comprising joints or deformable parallelograms between the pivot joint 7 and the kneepad 2, can moreover constrain the movement of the kneepad 2 perpendicular to the surface 5. In a variant, however, the force exertion direction is not strictly constant, but still remains substantially perpendicular to the surface 5 within a few degrees, typically plus or minus 15 degrees.

With reference to FIG. 2, the second embodiment of the device 100 will be described only with regard to its differences with respect to the first embodiment in FIG. 1.

The means 6 for increasing the mobilizing force comprise a restoring means, such as a spring, exerting a restoring force from the kneepad 2 towards the bearing surface 5, and gripping means (such as a lever or a handle) which are attached to the kneepad 2 and on which the user can push manually when their pelvis is on the bearing surface 5, so as to manually compensate for this restoring force. By pushing less and less or by pulling, the mobilizing force increases.

This restoring means (typically of the spring type) forms the linking element 9 connecting:
the kneepad 2 or an element attached to the kneepad 2
to the bearing surface 5 or to an element attached to the bearing surface 5.

With reference to FIG. 3, in the third embodiment of the device 100, the means 6 for increasing the mobilizing force comprise a step 26 attached to the kneepad 2 and arranged to receive a foot of a practitioner separate from the user so as to increase the mobilizing force by increasing a force exerted by the practitioner on the step 26.

The effect can be reduced by a mechanical system of the lever arm type (for example if the practitioner applies a weight smaller than the mobilizing force to be exerted).

The device 100 preferably comprises means (for example of the rack and/or pawl type) for accumulating the desired mobilizing force by applying successive efforts which mount up, in order to allow a progressiveness for dosing out the effort well.

The bearing surface 5 forms part of the device 100 and comprises a table, or a bed.

The means 7 comprise a guide 27 arranged to guide a movement of a part 25 connecting the kneepad 2 to the step 26. For example, this guide 27 is a hollow tube extending perpendicularly to the surface 5, and the linking part connecting the kneepad 2 to the step 26 is a sliding pin inside the hollow tube 27 perpendicular to the surface 5.

The device 100 can comprise at least one restoring means 11 (not illustrated) that is elastic (in extension and/or in compression, at least in extension) along the linking part 25, said restoring means 11 having a given rigidity or elasticity along the mechanical link 25 connecting the kneepad 2 to the step 26.

Each restoring means 11 has a rigidity of typical value.

A design with two linking elements 9, each equipped with an identical restoring means 11, in particular adapted to FIGS. 5, 9, 10, 13, 14 to 18, 21, 23, will instead be favoured, and trials have been performed with the following restoring means on the design in FIGS. 25 to 28:
Very elastic assembly, therefore suitable for frail and/or sensitive and/or small patients:
   F°, initial force, in other words minimum force to be applied in order to obtain a first deformation of the spring, equal to 127 N
   R, coefficient of rigidity of the spring equal to 0.92 N/mm With this equipment, a usage with quite a large elongation of the extensible linking elements is frequently noted. The patients stop their muscle stretches when the elongation has reached a value of between 20 mm and 50 mm.
   Here, the elongation of 20 mm corresponds to an applied force for the two springs of: 2*(F°+(R*20))=290 N
   The elongation of 50 mm corresponds to an applied force for the two springs of: 2*(F°+(R*50))=346 N, which is greater but remains a very reasonable force in the sense that it presents little risk to the patient.
Very rigid assembly, therefore suitable for patients in good physical shape:
   F°, initial force, in other words minimum force to be applied in order to obtain a first deformation of the spring, equal to 400 N.
   R, coefficient of rigidity of the spring equal to 27.9 N/mm.
   With this equipment, a usage with quite a small elongation of the extensible linking elements is frequently noted. The patients stop their muscle stretches when the elongation has reached a value of between 10 mm and 15 mm.
      The elongation of 10 mm corresponds to an applied force for the two springs of: 2*(F°+(R*10))=1358 N, which already corresponds to a pressure assessed to be high.
      The elongation of 15 mm corresponds to an applied force for the two springs of: 2*(F°+(R*15))=1637 N.

The first assembly can be considered as being well suited to the frailest patients and the second can be considered as being well suited to patients in very good physical shape, but it should be understood that the most important thing is the range of pressure applied to the knee, which can typically be from 300 N to 1600 N. It is one thing to choose the spring characteristics, but it is the manner of using them that creates the pressure. For example, a very frail person can use the second device with the spring with a rigidity of 27.9 N/m and in a posture that avoids creating a significant elongation, and can thus be subjected to only a pressure of 300 or 400 N.

As a further illustration, a spring that is a little more rigid than in the second assembly proposed can be chosen for the population of patients in good physical shape:
F°, initial force equal to 510 N instead of 400 N
R, coefficient of rigidity of the spring equal to 31.8 N/mm instead of 27.9 N/mm

With this equipment, a patient using the course up to an elongation of 5 mm will apply (for the two springs) a force equal to 2*(F°+(R*5))=1338 N and a patient using the course up to an elongation of 10 mm will apply (for the two springs) a force of: 2*(F°+(K*10))=1656 N.

It can be seen that the force values obtained here are quite similar to the forces obtained for the previous pair of springs. The course of applying pressure that is a little smaller has simply compensated for the use of a spring that is a little more rigid.

Finally, it is recalled that the use of such restoring means 11 is optional and that a direct application of tension to the knee is possible, supposing that the user knows how to dose out the pressure.

Each restoring means 11 therefore typically has a rigidity greater than 0.5 N/mm and/or smaller than 70 N/mm.

The device 100 can comprise means (not illustrated) for replacing the at least one restoring means 11 from different restoring means with different rigidity and/or means (not illustrated) for varying the rigidity of the at least one restoring means 11, applying the same principle as the thirteenth, fourteenth, fifteenth or sixteenth embodiment described below. This can comprise for example a set of several interchangeable springs and/or a spring with adjustable force.

With reference to FIG. 4, in the fourth embodiment of the device 100, the bearing surface 5 forms part of the device 100 and comprises a table, or a bed.

The device 100 comprises at least one linking element 9 connecting:
the kneepad 2 or an element attached to the kneepad 2
to the bearing surface 5 or to an element attached to the bearing surface 5.

The at least one linking element 9 comprises at least one strap, preferably two straps or even four straps, connecting the kneepad 2 or an element attached to the kneepad 2 to the surface 5 or to an element attached to the bearing surface 5. These two or four straps are respectively hooked up to two opposite sides of the kneepad 2 (one strap on each side of the kneepad 2, or a pair of straps on each side, i.e. on the right side or on the left side of the user with respect to their median plane).

The means 6 for increasing the mobilizing force comprise means 12 for shortening at least one of the linking elements 9 or each linking element 9, more precisely means 12 for shortening at least one of the straps or each strap. These means 12 typically comprise a winder (for example a manual winder, typically with a crank) for each strap or common to several straps.

In the case in FIG. 4, each strap is equipped with a winder for balancing the tensions of these two straps.

The two straps or the two pairs of straps are arranged to pull to the right and to the left, respectively, of a sagittal plane of the user whose knee 3 is covered by the kneepad 2 (this sagittal plane passing through the kneepad 2).

The means 7 comprise the two straps or two pairs of straps, which are arranged in order to pull, in a balanced manner, to the right and to the left of the kneepad 2, so as to keep the mobilizing force inside the fixed plane 4 parallel to the median plane of the user.

In a preferred case with four straps (not illustrated), each pair of straps to the right or to the left, respectively, of a sagittal plane of the user (this sagittal plane passing through the kneepad 2) comprises two straps which are arranged in order to pull, in a balanced manner, forwards and backwards parallel to this sagittal plane of the user.

It is noted that the use of four straps makes it possible to drive the kneepad according to a constrained course without ever obliging the patient to muscularly hold their posture, even if the direction of the force is not in the axis of the femur.

With reference to FIG. 5, in the fifth embodiment of the device 100, the bearing surface 5 forms part of the device 100 and comprises a backrest of a chair or an armchair.

The means 6 for increasing the mobilizing force comprise:
a weight attached to the kneepad 2, and
a sliding surface arranged to guide, by the gravitational effect, a fall of the weight and the kneepad 2 along the sliding surface against the user's knee 3. The user can hold back this fall with a hand or their other leg or a dedicated mechanism.

The means 7 comprise a guide, for example a rectilinear slide (preferably arranged on the sliding surface) and arranged to constrain the movement of the kneepad 2 parallel to the plane 4 according to a preferably rectilinear course.

With reference to FIG. 8, the eighth embodiment of the device 100 will be described only with regard to its differences with respect to the fourth embodiment in FIG. 4.

In this eighth embodiment, only one strap 9 is equipped with a winder 12, the other strap 9 is equipped with a spring 11. These two straps are attached to and continue on from each other, such that the winder has a simultaneous effect on the two straps in order to pull, in a balanced manner, to the right and to the left of the kneepad 2, so as to keep the mobilizing force inside the fixed plane 4 parallel to the user's median plane.

With reference to FIG. 9, the ninth embodiment of the device 100 will be described only with regard to its differences with respect to the eighth embodiment in FIG. 8.

In this embodiment, each strap 9 is connected not to the surface 5, but to an element 16 attached to the surface 5 and arranged to shorten the length of each strap 9.

Each element 16 is arranged:
to block lateral movements of the knee 3 and thus to constrain the relative movement of the kneepad 2 parallel to the plane 4, and/or
to allow an anchoring point of the straps higher than the surface (i.e. closer to the kneepad 3), which makes it possible to reduce the instabilities of the kneepad 2.

In this embodiment, as in other embodiments, the means for shortening at least one of the linking elements can be motorized.

With reference to FIG. 10, the tenth embodiment of the device 100 will be described only with regard to its differences with respect to the fourth embodiment in FIG. 4.

In this embodiment, the means 6 for increasing the mobilizing force comprise means for increasing a volume of an interface arranged inside the kneepad 2 and provided to be arranged between the kneepad 2 and the knee 3.

For this, the kneepad 2 comprises:
an inflatable cushion arranged in the kneepad 2 and provided to be arranged between the kneepad 2 and the knee 3, and
inflating means, such as a hand or finger pump, or an electric pump, arranged to inflate the inflatable cushion.

Part a) of FIG. 10 shows a diagrammatic representation of the cushion not inflated and part b) of FIG. 10 shows the cushion in the process of being inflated, and therefore during the increase in the mobilizing force.

With reference to FIG. 11, the eleventh embodiment of the device 100 will be described only with regard to its differences with respect to the fourth embodiment in FIG. 4.

In this embodiment, the means 6 for increasing the mobilizing force comprise means for increasing a volume of an interface arranged inside the kneepad 2 and provided to be arranged between the kneepad 2 and the knee 3.

For this, the kneepad 2 comprises:
a movable piston, or an endless screw, etc. arranged in the kneepad 2 and provided to be arranged between the kneepad 2 and the knee 3 and preferably equipped with a non-return system (for example a rack or a valve for a pneumatic system), and
displacement and/or guiding means, such as a slide, arranged to push the piston in the direction of the knee 3.

Part a) of FIG. 11 shows the piston in its initial position and part b) of FIG. 11 shows the piston in the process of being displaced against the knee 3 and therefore during the increase in the mobilizing force.

With reference to FIG. 12, the twelfth embodiment of the device 100 will be described only with regard to its differences with respect to the fourth embodiment in FIG. 4.

In this embodiment, the means 6 for increasing the mobilizing force comprise means for increasing a volume of an interface arranged on the bearing surface 5 and provided to be arranged between the bearing surface 5 and the pelvis.

For this, the device 100 comprises:
a cushion arranged on the surface 5, and
inflating means (for example pneumatic, such as a hand or finger or foot or electric pump) and/or displacement means (for example by the endless screw or lever arm or cam effect), arranged to inflate or displace, respectively, the cushion towards the kneepad.

Part a) of FIG. 12 shows the cushion not inflated and part b) of FIG. 12 shows the cushion in the process of being inflated, and therefore during the increase in the mobilizing force.

The different embodiments in FIGS. 1 to 5 and 8 to 12 can be combined with each other.

With reference to FIGS. 6 and 13 to 23 and 25 to 28, a second family of embodiments of devices 100 will now be described.

In the embodiments in FIGS. 6 and 13 to 23 and 25 to 28 the means 7 arranged to constrain the relative movement of the knee with respect to the bearing surface are arranged to keep the position of the mobilizing force exertion plane 4 parallel to the median plane of the user fixed during the increase in the mobilizing force, while allowing the direction of the mobilizing force to progress gradually relative to the increase in the mobilizing force, but not to keep the direction of the mobilizing force fixed during the increase in the mobilizing force.

The plane 4 is parallel to the plane of FIGS. 6, 13, 15, 17, 18.

The plane 4 is perpendicular to the surface 5.

The bearing surface 5 forms part of the device 100 and comprises a table, or a bed.

The mobilizing force has a direction parallel to a straight line perpendicular to the surface 5 plus or minus 30°.

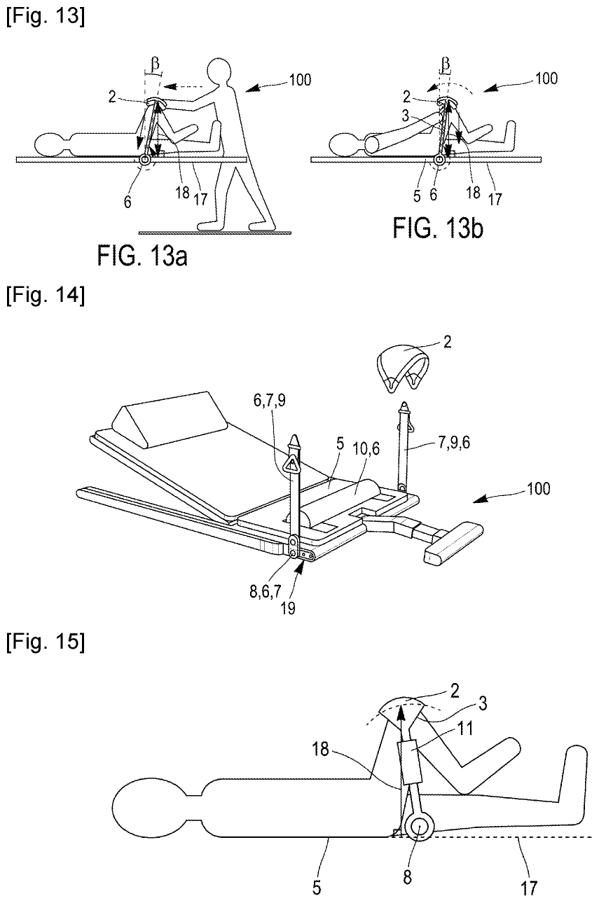

The mobilizing force has a direction which forms an angle β with a straight line perpendicular to the surface 5 and passing through the axis 8 or 30, β being:
positive when the mobilizing force is borne by a sloping straight line on the side of the user's feet with respect to this straight line perpendicular to the surface 5 (as illustrated in FIG. 13),
negative when the mobilizing force is borne by a sloping straight line on the side of the user's head with respect to this straight line perpendicular to the surface 5 (as illustrated in FIG. 15).

The value of this angle β decreases during the increase in the mobilizing force.

The value of this angle β:
is initially smaller than or equal to 30° for a zero or negligible value of the mobilizing force and/or
preferably has a final value smaller than or equal to 30° and/or greater than or equal to −30° (and for example equal to zero) for a maximum value of the mobilizing force over the course of the kneepad 2.

The means 6 for increasing the mobilizing force are arranged to increase this mobilizing force:
while increasing a distance 18 between the kneepad 2 and the bearing surface 5 or a plane 17 tangential to the bearing surface 5 when P is positive
while decreasing a distance 18 between the kneepad 2 and the bearing surface 5 or a plane 17 tangential to the bearing surface 5 when P is negative.

By the distance 18 between the kneepad 2 and the bearing surface 5 or a plane tangential to the bearing surface 5 is meant the distance 18 of the shortest segment connecting a defined point of the kneepad 2 to the bearing surface 5 or to the plane tangential to the bearing surface 5, i.e. the distance along the vertical projection from this defined point of the kneepad 2 onto the bearing surface 5 or onto the plane tangential to the bearing surface 5.

The means 6 for increasing the mobilizing force are arranged to increase this mobilizing force while decreasing the angle β.

The means 7 arranged to constrain the relative movement of the kneepad 2 with respect to the bearing surface 5 according to a constrained course are arranged to constrain the relative movement of the kneepad 2 with respect to the bearing surface 5 according to a rotational movement of the kneepad 2 preferably about an axis of rotation 8 parallel to the surface 5.

The device 100 comprises at least one linking element 9 connecting:
the kneepad 2 or an element attached to the kneepad 2
to the bearing surface 5 or to an element attached to the bearing surface 5.

The at least one linking element 9 comprises at least one strap or a rod.

The device 100 comprises, on the bearing surface 5 or on an element attached to the surface 5, a pivot pin 8 of the kneepad 2, the at least one linking element 9 connecting the pivot pin 8 to the kneepad 2 and being arranged to pivot about the pivot pin 8, causing the kneepad 2 to pivot about the pivot pin 8.

The pivot pin 8 can be a mechanical pivot or articulated link or a simple strap stapling point.

The device 100 comprises a mark or a stop 10 arranged to make it possible to position the user's pelvis offset with respect to the pivot pin 8.

The means 6 for increasing the mobilizing force are arranged to increase this mobilizing force by pivoting the kneepad 2 about the pivot pin 8 such that, in projection onto a plane tangential to the surface 5, the pivot pin 8 of the kneepad 2 is offset (typically by at least 5 cm) with respect to the pivot point of the knee 3 with respect to the pelvis.

With reference to FIGS. 13 to 18, in the thirteenth embodiment of the device 100, the at least one linking element 9 comprises two straps 9, connecting two sides of the kneepad 2 to two anchoring points arranged along the pivot pin 8. Each strap 9 connects the kneepad 2 to the surface 5 or to an element attached to the bearing surface 5. These two straps 9 are hooked up to two opposite sides of the kneepad 2 respectively (one strap on each side, right or left, of the kneepad).

The means 6 for increasing the mobilizing force comprise the pivot pin 8 which, in projection onto a plane tangential to the surface 5 or in projection onto the surface 5 if this surface 5 is flat, is offset with respect to the pivot point 30 of the femur in the pelvis and/or of the knee 3 with respect to the pelvis, as explained previously. The means 6 for increasing the mobilizing force are arranged to increase this mobilizing force by pivoting the elements 9 (straps) about the pivot pin 8.

The two straps are arranged to pull to the right and to the left, respectively, of the sagittal plane of the user whose knee 3 is covered by the kneepad 2 (this sagittal plane passing through the kneepad 2).

The means 7 comprise the two straps, which are arranged to pull, in a balanced manner, to the right and to the left of the kneepad 2, so as to keep the mobilizing force inside the fixed plane 4 parallel to the median plane of the user.

Part a) of FIG. 13 corresponds to the start of the use of the device 100, for which the mobilizing force is zero or else small.

Part b) of FIG. 13 corresponds to the use of the device 100, for which the mobilizing force has increased and is not zero, through rotation of the kneepad 2 about the pivot 8.

This rotation can be made to happen by an external practitioner (illustrated only in FIG. 13a, but can also be translated to the case in FIG. 13b) or directly by the user (illustrated only in FIG. 13b, but can also be translated to the case in FIG. 13a) using a grip means attached to the kneepad 2.

The distance 18 in the case of part b) of FIG. 13 is greater than the distance 18 in the case of part a) of FIG. 13, while B decreases when passing from part a) of FIG. 13 to part b) of FIG. 13.

With reference to FIG. 14, it is noted that the device 100 comprises:
a reclinable backrest,
a headrest at the top of the backrest,
a toe clip.

Moreover, the device 100 comprises several positions 19 for fastening the elements 9 to the surface 5 or to an element attached to the bearing surface 5, making it possible to adjust different positions of the pin 8 according to the user's morphology.

The kneepad 2 is detachable thanks to elements 9 through connectors, for example through hooks.

With reference to FIG. 15, the device 100 comprises at least one restoring means 11 that is elastic (in extension and/or in compression) along the at least one linking element 9, said restoring means 11 having a given rigidity or elasticity along the mechanical link connecting the kneepad 2 to the bearing surface 5.

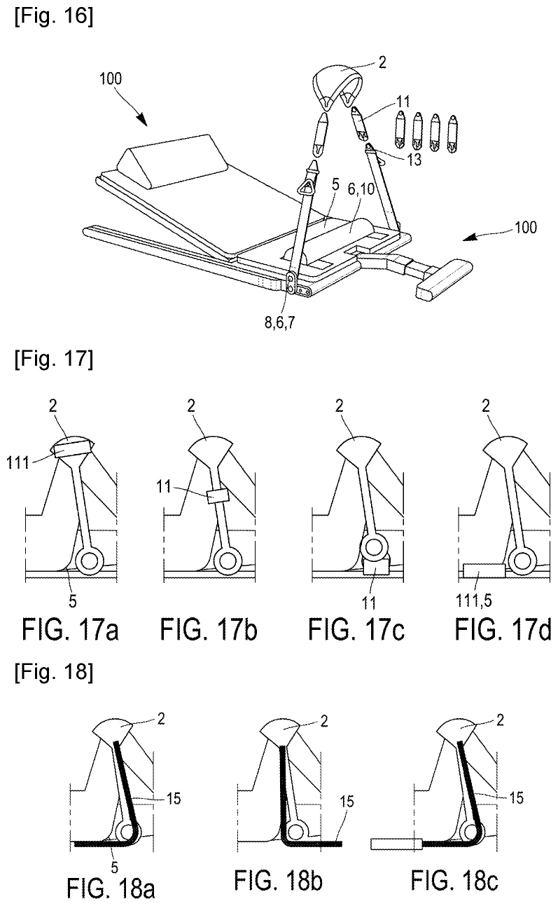

With reference to FIG. 16, the device 100 comprises means for replacing 13 the at least one restoring means 11 from different restoring means 11 with different rigidity and/or elasticity, and/or means 14 for varying the rigidity and/or elasticity of the at least one restoring means 11. Typically, the connectors making it possible to hook the kneepad 2 up to the elements 9 (straps) moreover make it possible to change the restoring means 11 for different values of rigidity, which makes it possible to adjust the device to different ranges of mobilizing forces to be applied, from the lowest values (for a child user or a user weakened by age or by wounds or surgical operations in the area mobilized by the stretching) to the highest values (for an adult user in good health, for example and in particular a sportsperson).

Each restoring means 11 can be located along (FIG. 17b) an element 9 or at an end (FIG. 16, FIG. 17c) of an element 9.

With reference to FIG. 17, the kneepad 2 (FIG. 17a) and/or the bearing surface 5 (FIG. 17d) comprises at least one restoring means 111 that is elastic (in extension and/or in compression), said restoring means having a given rigidity and/or elasticity arranged to have an influence on the mobilizing force exerted from the kneepad 2 towards the bearing surface 5. The effect of the means 111 is identical to that of the means 11.

With reference to FIG. 18, the device 100 preferably moreover comprises means 15 arranged to modify a lever arm applied to the kneepad 2 during its rotation about the pivot pin 8, such an additional strap being connected to the kneepad 2 and providing a cam effect by sliding of this additional strap about the pin 8 but at a certain non-zero distance from the pin 8.

With reference to FIGS. 19 to 20, the fourteenth embodiment of the device 100 will be described only with regard to its differences with respect to the thirteenth embodiment in FIGS. 13 to 18.

The at least one linking element 9 comprises an inextensible and/or incompressible rod (of adjustable length) attached to the kneepad 2.

The means 6 for increasing the mobilizing force are arranged to increase this mobilizing force by pivoting the inextensible and/or incompressible rod 9 about the pivot pin 8.

The means 7 comprise the pin 8, which allows a rotation of the inextensible and/or incompressible rod 9 only parallel to the plane 4.

The restoring means 11 is incorporated inside the rod 9.

A button 23 makes it possible to release the length adjustment of the linking element 9 by sliding. Another spring 20 has been provided in order to compensate for the weight of the top part of the device during the adjustment to the extent that the user can apply it to the knee delicately in order to adapt it to different morphologies of users, before pressure is put on by rotation about the pin 8.

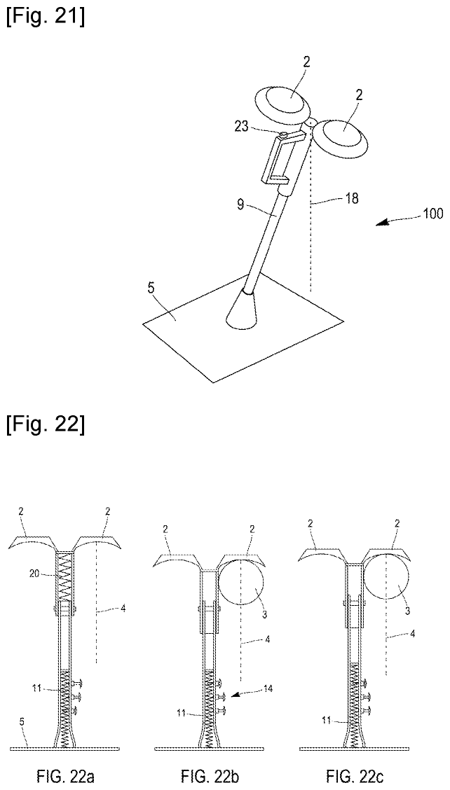

With reference to FIGS. 21 to 22, the fifteenth embodiment of the device 100 will be described only with regard to its differences with respect to the fourteenth embodiment in FIGS. 19 to 20.

With reference to FIG. 21, the button 23 is no longer located at the bottom, but is now at the top of the rod 9.

With reference to FIG. 22, the device 100 comprises means 14 for varying the rigidity of the at least one restoring means 11. Typically, different eyebolts make it possible to define the useful length of the spring 11 (i.e. the number of useful turns of the spring 11) and therefore its rigidity.

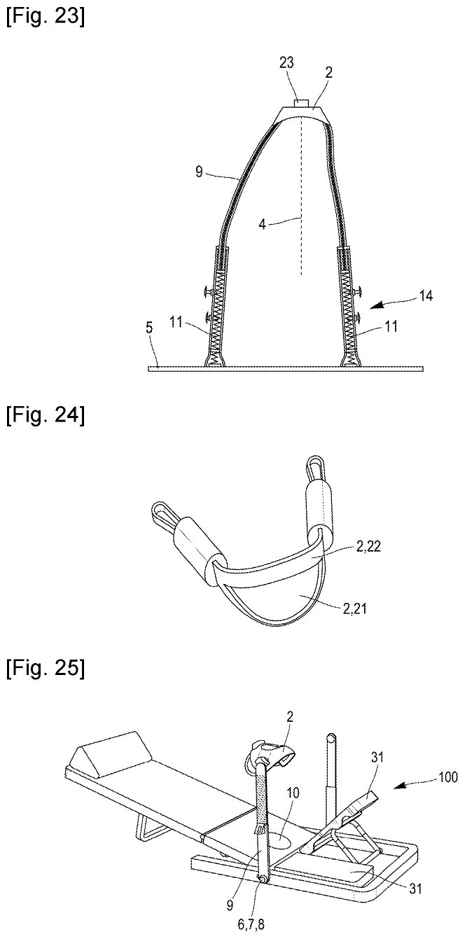

With reference to FIG. 23, the sixteenth embodiment of the device 100 will be described only with regard to its differences with respect to the thirteenth embodiment in FIGS. 13 to 18.

A button 23 (positioned on the kneepad 2) makes it possible to adjust the length of each strap 9 so as to adapt it to different user morphologies.

The device 100 comprises, preferably for each restoring means 11, means 14 for varying the rigidity of this restoring means 11. Typically, different eyebolts make it possible to define the useful length of the spring 11 (i.e. the number of useful turns of the spring 11) and therefore its rigidity.

With reference to FIGS. 25 to 28, the seventeenth embodiment of the device 100 will be described only with regard to its differences with respect to the thirteenth embodiment in FIGS. 13 to 18.

FIG. 25 is a general view of this embodiment.

It can be seen that the device 100 of this embodiment comprises two elements 9.

Each element 9 is inextensible but compressible (for example through a rack system).

Each element 9, right or left respectively, can be connected in turn to the kneepad 2 so that the kneepad 2 is arranged to be applied to the knee, right or left respectively, of the user.

It can be seen that the device 100 of this embodiment comprises two orientable paddles 31, each paddle 31, right or left respectively, being arranged to form a support surface with adjustable inclination for the thigh, right or left respectively, of the user while maintaining the contact with this thigh during the rotation of the kneepad 2 about the pin 8.

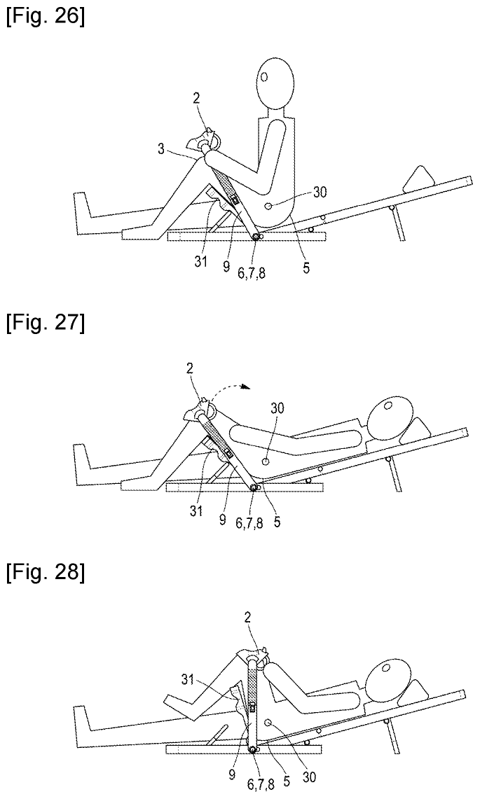

In FIG. 26 the user can be seen installing the kneepad 2 on their left knee (by positioning their left thigh against the left paddle 31).

In FIG. 27 the user can be seen starting the constrained course on their left knee 3 by rotation about the pin 8. The angle β is positive.

In FIG. 28 the user can be seen continuing the constrained course on the left knee by rotation about the pin 8. The angle β has decreased compared with FIG. 27. The mobilizing force has increased compared with FIG. 27. It is noted that, in this figure, the angle travelled is large and that β has even passed below zero degrees.

With reference to FIG. 6, in the sixth embodiment of the device 100, the bearing surface 5 forms part of the device 100 and comprises a backrest of a chair or an armchair.

The means 6 for increasing the mobilizing force comprise a receiving surface attached to the kneepad 2 and forming a corner with the bearing surface 5.

The device 100 moreover comprises means for adjusting the distance between the kneepad 2 and the corner in order to adapt the device 100 to different morphologies of users.

This receiving surface forms the linking element 9 connecting:
the kneepad 2 or an element attached to the kneepad 2
to the bearing surface 5 or to an element attached to the bearing surface 5.

The means 7 comprise the corner and the receiving surface of the kneepad 2, which make it possible, as the pelvis sinks into the corner, to keep the direction of the mobilizing force fixed.

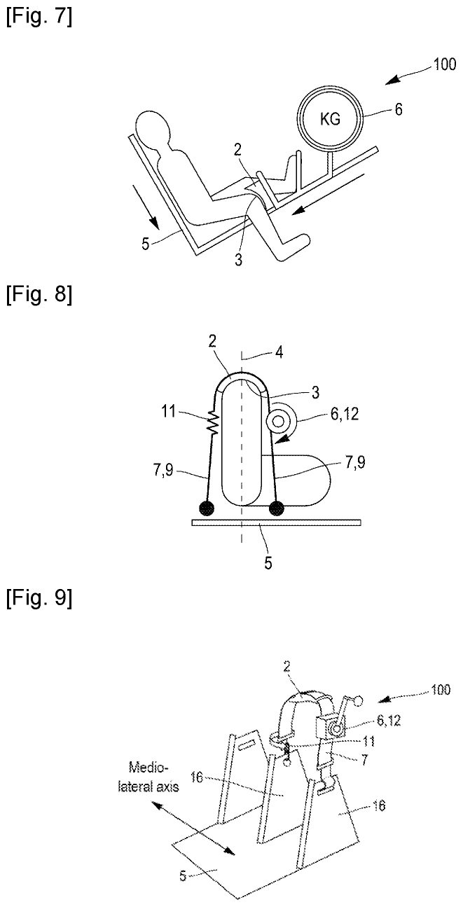

The seventh embodiment of the device 100 in FIG. 7 illustrates the possibility of combining the fifth and sixth embodiments.

With reference to FIG. 24, the kneepad 2 of any of the previously described embodiments comprises:
a central area 21 intended to be in contact with the patella of the knee 3 and a peripheral area 22 intended to surround the patella of the knee 3. Preferably, the peripheral area 22 has a greater rigidity than the central area 21, or
an empty central area 21 intended to be located at the patella of the knee 3 and a peripheral area 22 intended to surround the patella of the knee 3.

Of course, the invention is not limited to the examples that have just been described and numerous adjustments can be made to these examples without exceeding the scope of the invention.

Of course, the various characteristics, forms, variants and embodiments of the invention can be combined with one another in various combinations, provided that they are not incompatible or mutually exclusive. In particular, all the variants and embodiments described previously can be combined with each other.

For example, in variants which can be combined with each other from all of the previously described embodiments:
the means 6 for increasing the mobilizing force, when they comprise means 12 for shortening the at least one linking element 9, can comprise translation means for a pin that is elastic (in extension and/or in compression) or inextensible and/or incompressible, a sliding effect, a rack effect, etc., and/or
the kneepad 2 forms part of a set of two attached kneepads 2 (as illustrated for example in FIGS. 19 to 22), which makes it possible to mobilize only the right knee or only the left knee or both the right and the left knee of the user simultaneously, and/or
the device 100 comprises a system for measuring and displaying the value of the mobilizing force, such as a dynamometer arranged along one of the at least one elements 9, and connected to an analog or digital display. In this case, the system for measuring the mobilizing force can be incorporated directly in the kneepad 2 or can be incorporated in the or at least one of the linking elements 9 (the measurement system can comprise for example a traction force transducer incorporated along this linking element 9). The force display can be borne by the kneepad 2 and/or can be an LED and/or bar display and/or a digital and/or analog display. Such a display makes it possible for the user and/or the practitioner to manage the pressure applied to the knee and can be likened to a safety device, and/or
a succession of extensible, compressible, inextensible segments as well as segments that make an adjustment possible can be found on one and the same linking element, the purpose being the described one of applying a pressure to the knee of a user in the direction of their hip, and/or
the means 6 for increasing the mobilizing force can be motorized, and/or
the constrained course of the kneepad can be any, with a fixed plane 4 or not. For example, in a variant of the embodiments in FIGS. 23, the plane 4 can be perpendicular or oblique to the median plane of the user so as to bring the kneepad 2 towards the median plane of the user
each restoring means 11 or 111 can be arranged to exert a force pulling or pushing the kneepad 2 against the knee 3:
   by extension of this restoring means 11, 111 in a compressed state of this restoring means 11, 111 with respect to a balanced state of this restoring means 11, 111, or
   by compression of this restoring means 11, 111 in an extended state of this restoring means 11, 111 with respect to a balanced state of this restoring means 11, 111.

1. A device for mobilizing the human osteo-musculotendinous system, comprising:
a kneepad, arranged to cover a knee of a human user so as to hold the knee in the kneepad, and said kneepad being arranged to exert a mobilizing force on the knee covered by the kneepad;
said mobilizing force putting pressure on the knee and being directed towards a bearing surface arranged to support the user's pelvis;
said mobilizing force having a direction that leads from the kneepad to the bearing surface; and
means for increasing the mobilizing force.

2. The device according to claim 1, characterized in that it moreover comprises means arranged to constrain, during the increase in the mobilizing force by the force-increasing means, the relative movement of the kneepad with respect to the bearing surface according to a constrained course, the mobilizing force having its direction contained in a mobilizing force exertion plane, the means arranged to constrain the relative movement of the knee with respect to the bearing surface are arranged to keep the position of the mobilizing force exertion plane fixed during the increase in the mobilizing force.

3. The device according to claim 2, characterized in that the means arranged to constrain the relative movement of the knee with respect to the bearing surface are arranged to keep the direction of the mobilizing force fixed during the increase in the mobilizing force.

4. The device according to claim 1, characterized in that the means for increasing the mobilizing force comprise:
a grip element which is attached to the kneepad and on which the user can pull manually when their pelvis is on the bearing surface.

5. The device according to claim 1, characterized in that the means for increasing the mobilizing force comprise:
a restoring means, such as a spring exerting a restoring force from the kneepad towards the bearing surface, and means for compensating for this restoring force.

6. The device according to claim 1, characterized in that the means for increasing the mobilizing force comprise:
a step attached to the kneepad and arranged to receive a foot of a practitioner separate from the user so as to increase the mobilizing force by increasing a force exerted by the practitioner on the step.

7. The device according to claim 1, characterized in that the means for increasing the mobilizing force comprise:
a weight attached to the kneepad and preferably a sliding surface arranged to guide, by the gravitational effect, a fall of the weight and the kneepad along the sliding surface against the user's knee.

8. The device according to claim 1, characterized in that the means for increasing the mobilizing force comprise:
a receiving surface which is attached to the kneepad and forms a corner with the bearing surface, and means for adjusting the distance between the kneepad and the corner.

9. The device according to claim 1, characterized in that the means for increasing the mobilizing force comprise:
means for increasing a volume of an interface arranged inside the kneepad and provided to be arranged between the kneepad and the knee.

10. The device according to claim 1, characterized in that the means for increasing the mobilizing force comprise:
means for increasing a volume of an interface arranged on the bearing surface and provided to be arranged between the bearing surface and the pelvis.

11. The device according to claim 1, characterized in that the means for increasing the mobilizing force are arranged to increase this mobilizing force while decreasing a distance between the kneepad and the bearing surface.

12. The device according to claim 1, characterized in that the means for increasing the mobilizing force are arranged to increase this mobilizing force while increasing a distance between the kneepad and a plane tangential to the bearing surface.

13. The device according to claim 1, characterized in that it comprises at least one linking element connecting:
the kneepad or an element attached to the kneepad;
to the bearing surface or to an element attached to the bearing surface.

14. The device according to claim 13, characterized in that the at least one linking element comprises at least one strap or a rod.

15. The device according to claim 13, characterized in that it comprises at least one restoring means that is elastic along the at least one linking element, said restoring means having a given rigidity along the mechanical link connecting the kneepad to the bearing surface.

16. The device according to claim 15, characterized in that it comprises means for replacing the at least one restoring means from different restoring means with different rigidity and/or means for varying the rigidity of the at least one restoring means.

17. The device according to claim 13, characterized in that it comprises the bearing surface and in that it comprises, on the bearing surface or on an element attached to the bearing surface, a pivot pin of the kneepad, the at least one linking element connecting the pivot pin of the kneepad to the kneepad and being arranged to pivot about the pivot pin, causing the kneepad to pivot about the pivot pin.

18. The device according to claim 17, characterized in that it comprises a mark or a stop arranged to make it possible to position the user's pelvis offset with respect to the pivot pin.

19. The device according to claim 17, characterized in that the pivot pin of the kneepad is offset with respect to the pivot point of the knee with respect to the pelvis such that the means for increasing the mobilizing force are arranged to increase this mobilizing force by pivoting the kneepad about the pivot pin.

20. The device according to claim 17, characterized in that the at least one linking element comprises an inextensible and/or incompressible rod attached to the kneepad, the means for increasing the mobilizing force being arranged to increase this mobilizing force by pivoting the inextensible and/or incompressible rod about the pivot pin.

21. The device according to claim 17, characterized in that the at least one linking element comprises two straps connecting two sides of the kneepad to two anchoring points arranged along the pivot pin, the means for increasing the mobilizing force being arranged to increase this mobilizing force by pivoting the straps about the pivot pin.

22. The device according to claim 17, characterized in that it comprises means arranged to modify a lever arm applied to the kneepad during its rotation about the pivot pin.

23. The device according to claim 13, characterized in that the means for increasing the mobilizing force comprise means for shortening the at least one linking element.

24. The device according to claim 1, characterized in that the bearing surface forms part of the device and comprises:
a backrest of a chair or an armchair, or
a table, or
a bed.

25. The device according to claim 1, characterized in that the kneepad comprises:
a central area intended to be in contact with the patella of the knee and a peripheral area intended to surround the patella of the knee, the peripheral area having a greater rigidity than the central area, or
an empty central area intended to be located at the patella of the knee and a peripheral area intended to surround the patella of the knee.

26. The device according to claim 1, characterized in that the kneepad forms part of a set of two attached kneepads.

27. The device according to claim 1, characterized in that it comprises a system for measuring and displaying the value of the mobilizing force.

28. The device according to claim 1, characterized in that:
the kneepad comprises at least one restoring means that is elastic; and/or
it comprises the bearing surface and in that the bearing surface comprises at least one restoring means that is elastic;
said restoring means having a given rigidity arranged to have an influence on the mobilizing force exerted on the kneepad towards the bearing surface.
